(19) United States
(12) Patent Application Publication
(10) Pub. No.: US 2013/0006884 A1
(43) Pub. Date: Jan. 3, 2013

(54) Computer System for Managing, Assessing, and Optimizing Tuition Reimbursement and Method of its Operation

(75) Inventors: Craig V. Carroll, Double Bay (AU); John F. Deleppo, Franklin, MA (US); Christina E. Kline, Brockton, MA (US); Margaret Lynn Raiche, Minnetrista, MN (US); Donald J. Singleton, Sacramento, CA (US)

(73) Assignee: REZOLVE GROUP, INC., Sacramento, CA (US)

(21) Appl. No.: 13/174,014

(22) Filed: Jun. 30, 2011

(51) Int. Cl. G06Q 10/06

(52) U.S. Cl. 705/322

(57) ABSTRACT

A method and system for managing, assessing, and optimizing tuition reimbursement for an employee by an employer and optimizing financial outcomes for an employee relative to tuition reimbursement programs. Employee tuition reimbursement eligibility information is entered into a computer system and the computer system determines whether the employee is eligible for tuition reimbursement by comparing the employee tuition reimbursement eligibility information to tuition reimbursement eligibility criteria for the employer. Furthermore, if the employee is determined to be eligible for the tuition reimbursement, entering employee financial aid eligibility information into the computer system. Determining a financial aid award that is generated from the employee financial aid eligibility information of the employee and determining an amount of tuition reimbursement based on the financial aid awards and/out of pocket costs incurred by the employee. Potential adjustments to tuition reimbursement eligibility are made, in one example, based on financial aid eligibility possibilities determined through modification of input parameters.

### BACKGROUND OF THE INVENTION

Many employers provide an array of benefits as part of a compensation package offered to their employees. Some examples of benefits include health and dental insurance, retirement plans, disability pay, paid vacation days, company stock purchasing plans, subsidies for health club memberships, or subsidies for using public transportation, to list a few examples.

Similarly, many companies offer tuition reimbursement for a variety of reasons. For example, tuition reimbursement is offered to attract potential employees, to allow current employees an opportunity to gain training and experience, to prepare younger employees to replace retirees, or simply as an incentive for current employees to remain with the employer.

Offering tuition reimbursement benefits can be expensive for the employer, yet the employer may not want to decrease the value of the benefit to the employees since it functions a tool for keeping good employees at the company. On the other hand, often the tuition reimbursement provided by the employer only covers a small part of the employee's tuition costs. This problem is exacerbated by the fact that the cost of higher education has been increasing considerably faster than wages.

Most employees who apply for tuition reimbursement do not avail themselves of financial aid available from federal or state governments or from the schools they attend. Employees may not have an incentive to apply for financial aid if they are being fully reimbursed for the costs of their education. Employees may also be unaware of various options available that would qualify them for financial aid, or for additional financial aid. If an employee were to solicit financial aid and/or structure his academic career in a manner that would enable him to maximize available financial aid, the employer could save considerable amounts in tuition reimbursement and potentially offer tuition reimbursement programs to a broader employee population as a result.

### SUMMARY OF THE INVENTION

A problem with current practices is that employees typically do not maximize the amount of financial assistance from different potential sources because of the lengthy, confusing, and disparate application processes and the plethora of federal, state, military and institutional aid programs. Moreover, employees who are receiving full reimbursement from their employer may not have an incentive to apply for financial assistance. Employees may also be unaware that decisions they make may impact both the availability and the amount of financial aid for which they may qualify.

An employer wants to deliver as much guidance and support as possible to employees relative to aid eligibility in order to provide a valuable service to employees, minimize the employer's cost for the tuition reimbursement benefit on an individual basis with the potential of expanding the benefit to a broader group of employees, or utilize limited tuition reimbursement program resources more efficiently. With current systems, neither employees nor employers are well-positioned to prospectively assess the net cost of the employees' educational ambitions, or minimize those costs through the planning and execution of strategies to maximize financial aid. Tuition reimbursement is typically granted based on the top line tuition cost rather than the employee's net cost after accounting for the possibility of financial aid, and employers typically do not provide resources to promote the maximization of financial assistance from government and institutional sources.

Thus, there is a need for a comprehensive computer system and associated method that helps employers streamline the administration of tuition reimbursement benefits while minimizing the cost of the benefit to the employer as well as the cost of the educational program to the employee. Furthermore, there is a need for a comprehensive tuition reimbursement management system that helps employees complete the entire financial aid application process prior to qualifying for a tuition reimbursement benefit and obtain the maximum amount of tuition assistance from all the different financial aid resources available to the employee while enabling the employer to account for that financial aid in administering the tuition reimbursement benefit. There is also a need for a comprehensive computer system and associated method that assists the employee to make informed educational decisions that optimize the availability of financial assistance.

Typically, the computer system is either a separate third party system or an additional system integrated into the company's existing data management infrastructure. The computer system is capable of screening candidates to determine eligibility for tuition reimbursement by the employer. The computer system allows an employee to answer a series of questions organized as a cohesive application. The computer system gathers information entered by the employee and then parses and loads the data into various financial aid and tuition reimbursement applications.

One result is that employees experience a single, streamlined application process from inception through completion of educational objectives. The computer system then prepares the different applications on the employees' behalf. Likewise, the computer system benefits employers because it is scalable as the company grows, reduces manpower requirements to administer benefits, and helps the employers maximize financial aid benefits available to the employee to thereby reduce the cost of the tuition reimbursement benefit to the employer and reduce educational costs for the employee, since the benefit can now be administered based on the employee's net cost after accounting for financial aid from the different sources.

In general, according to one aspect, the invention features a computerized method for managing tuition reimbursement for an employee by an employer. The method comprises entering employee tuition reimbursement eligibility information into a computer system, determining whether the employee is eligible for tuition reimbursement based on tuition reimbursement eligibility criteria, if the employee is determined to be eligible for the tuition reimbursement program entering employee financial aid eligibility information into the computer system, and submitting an application for financial aid that includes the employee financial aid eligibility information obtained from the employee.

In aspects of embodiments, the method also includes entering into the computer system financial aid awards that were generated from the application for financial aid of the employee and the computer system determines an amount of tuition reimbursement based on the financial aid awards. In this way, the value of the benefit is informed by the net cost of tuition to the employee, which accounts for the value of any financial aid that the employee receives.

Usually, the employee tuition reimbursement eligibility information includes employment status and tenure of employment. The tuition reimbursement eligibility criteria for the employer includes whether a program includes appropriate funds for reimbursement of expenses of the employee. Preferably, at least some of the employee tuition reimbursement eligibility information is transferred from a human resources computer system. In some examples, the computer system actually generates a tuition reimbursement check amount that is determined in part based on the financial aid awards.

In general, according to another aspect, the invention features a computer system for managing tuition reimbursement for an employee by an employer. The computer system receives employee tuition reimbursement eligibility information and determines whether the employee is eligible for tuition reimbursement based on tuition reimbursement eligibility criteria. If the employee is determined to be eligible for the tuition reimbursement, the computer system receives employee financial aid eligibility information and generates and submits an application for financial aid that includes the employee financial aid eligibility information obtained from the employee.

In general, according to another aspect, the invention features a computerized method for managing tuition reimbursement for an employee by an employer. This method comprises receiving employee tuition reimbursement eligibility information, determining whether the employee is eligible for tuition reimbursement based on tuition reimbursement eligibility criteria, if the employee is determined to be eligible for the tuition reimbursement, determining if financial aid eligibility of the employee will improve with changes in status, and then determining financial aid eligibility based on a new status.

In embodiments, the new status is a fulltime status and/or an increased number of credit hours. In some cases, available tuition reimbursement is limited if the employee is unwilling to transition to a new status.

In general, according to another aspect, the invention features a computer system for managing tuition reimbursement that performs this method.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 schematic diagram illustrating the interrelation between an employee, a call center advisor, and the inventive computer system.

FIGS. 2 and 2A are flow charts illustrating the steps for managing tuition reimbursement for an employee by the employer's computer system.

FIG. 3 shows the graphical user interface and online tuition reimbursement application completed by an employee during the application process.

FIG. 4 is a block diagram showing the relationship between the computer system and the billing and reporting system.

### DETAILED DESCRIPTION OF THE PREFERRED EMBODIMENTS

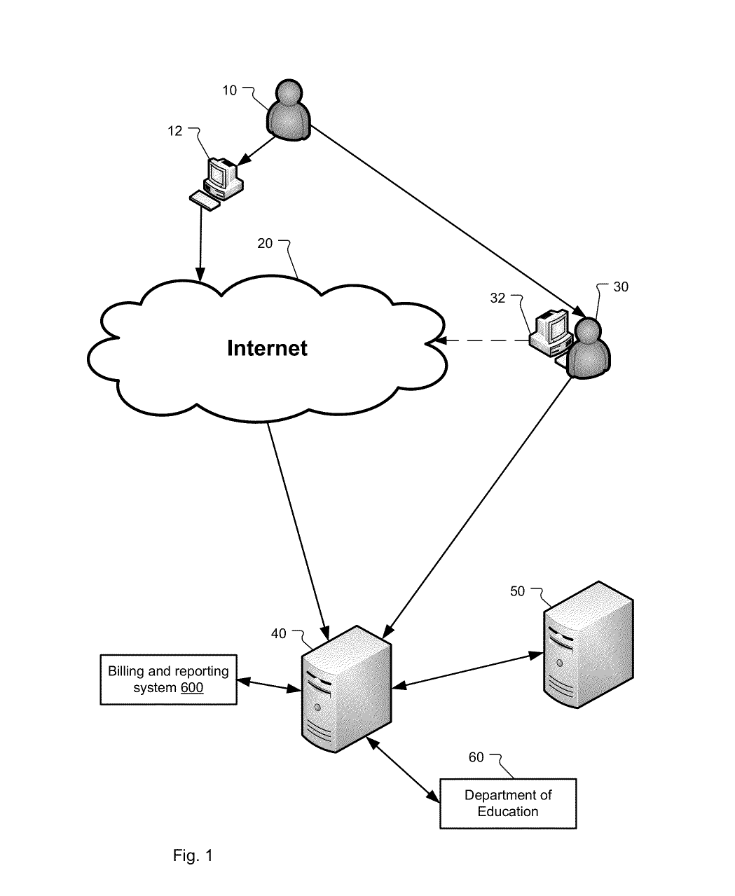

FIG. 1 illustrates the relationship between an employee 10, a call center advisor 30, and the computer system 40, billing system 600, and human resources computer system 50. Further, the computer system 40 preferably interfaces with the Department of Education 60 to enable the submission of financial aid forms and ascertain the status of financial aid requests by the employees.

In a typical implementation, an employee 10 uses an employee or personal computer 12 to connect to the computer system 40 via the Internet or other public or private computer network 20. The employee 10 uses a browser to navigate to a website hosted by the computer system 40 in the preferred embodiment. A graphical user interface is presented to the employee 10 on the employee computer 12. The interface presents information, instructions, and questions that the employee must complete as part of the application process. That employee-entered information is transmitted to the computer system 40.

Alternatively, in a different implementation, the employee contacts an advisor 30 in a call center. The advisor 30 uses an advisor computer 32 that communicates with the computer system 40. The advisor asks the questions to the employee that are presented by the graphical user interface and then enters the responses from the employee into fields within the graphical user interface displayed on the advisor computer 32. This information is then transferred to the computer system 40. The advisor computer 32 is typically connected to the computer system 40 via a private network or via a public network such as the Internet 20.

Typically, the computer system also communicates with a billing and reporting system 600 and an employer human resources computer system 50. The billing and reporting system 600 stores and analyzes statistical information related to the tuition reimbursement program offered by the employer. The employer human resources (HR) computer system 50 typically manages employees' personal information for the employer.

In some examples, the HR computer system 50 is actually managed by a third party that functions as an agent for the employer of the employee 10. This occurs in the situations where the company/employer outsources some or all of the various HR processes, which may include tuition reimbursement management. Thus, in this example, the computer system 40 actually directly interfaces with the vendor and not the employer.

In a similar vein, the computer system 40 is owned and operated by the employer in some examples. In other case, the computer system is operated by a third party that brands the user interface such that it appears to be operated by the employer.

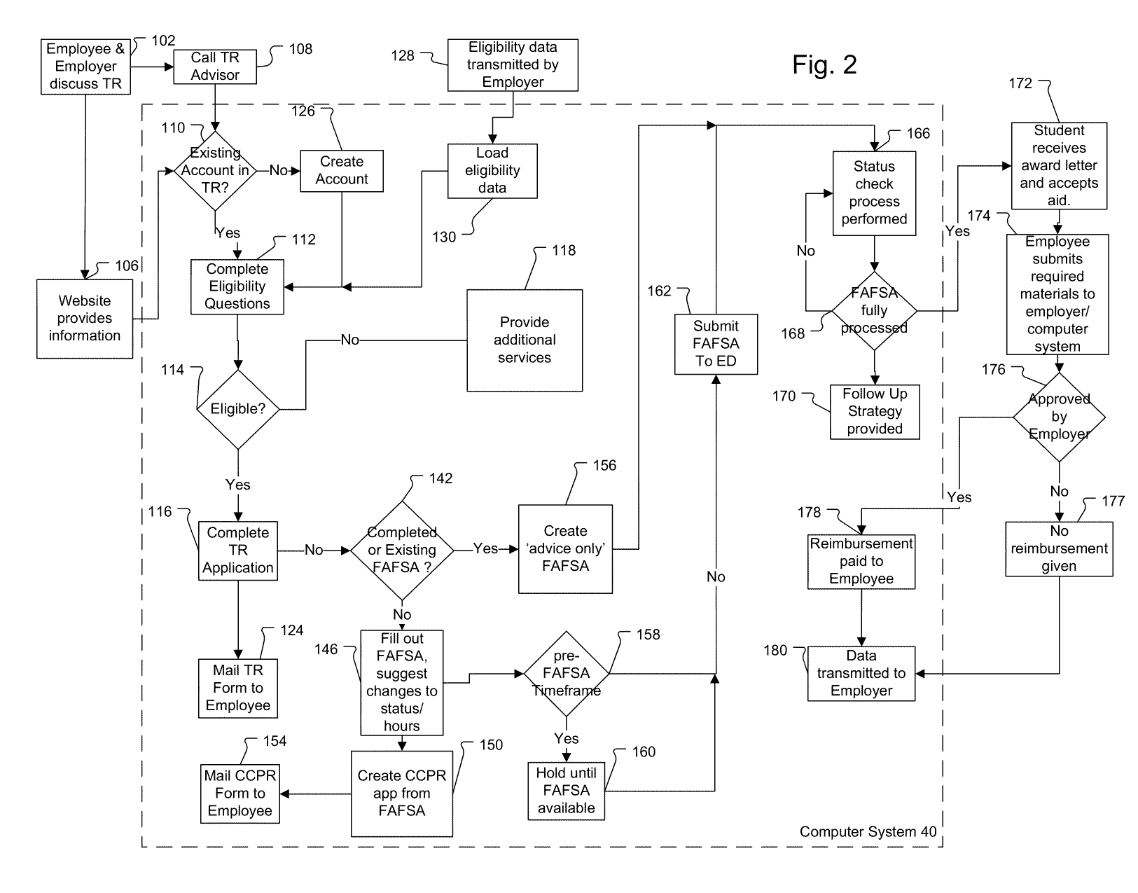

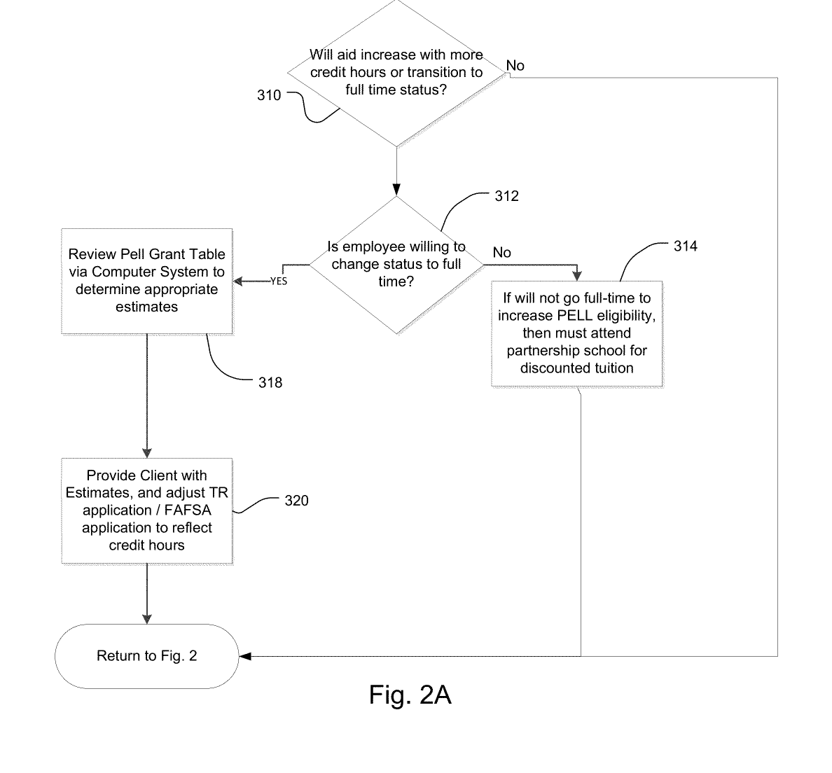

FIG. 2 is a flow chart illustrating the steps for managing tuition reimbursement for employees 10 by the computer system 40.

In the first step 102, an employee 10 and usually a representative of the employer discuss the employer's benefits and the tuition reimbursement program. Typically, the discussion is between the employee and a supervisor. If the supervisor approves the employee for the tuition reimbursement program, then the employee is provided access to an informational website generated by computer system 40 containing further information about the tuition reimbursement program and any policies, rules, or regulations of the tuition reimbursement program in step 106. In a typical implementation, the website is a private website and only available to employees of the employer/company. In an alternative embodiment, the website is available to the general public. In yet another embodiment, the website is restricted to authorized employees only or employees that have been prescreened for tuition reimbursement eligibility.

Typically, an employee begins the tuition reimbursement process by accessing the computer system 40 at the employee computer 12 via the Internet 20. Alternatively, the employee also has the option to speak with the advisor 30 in a call center to discuss the tuition reimbursement (TR) program in step 108. In step 110, the computer system 40 determines if the employee has an existing account within the computer system 40. If the employee does not have an account, then one is created in step 126. This includes the employee's name and possibly other identifying information such as social security number and employee ID number.

Then the employee completes the employee tuition reimbursement eligibility questions in step 112. In a preferred embodiment, tuition reimbursement eligibility information is entered by the employee at their computer over the Internet 20. A graphical user interface guides the employee through a series of screens or windows with information, directions, and questions that need to be completed by the employee and entered into the computer system 40.

In an alternative embodiment, advisor 30 working at the call center uses the advisor computer 32 and views a graphical user interface that is similar to the graphical user interface presented to the employee to guide the advisor 30 (and thus the employee) through the tuition reimbursement eligibility questions and obtain the eligibility information from the employee over the phone. The advisor 30 enters information obtained from the employee 10 into the computer system 40.

Generally, tuition reimbursement eligibility questions include:
What is the employee's full time or part time status?
What is the employee's tenure?

Other information including further tuition reimbursement eligibility information covers the employer qualifying specifics for the employee. These questions/information include?
What is the employee's degree choice?
What is the employee's college/institution status?
What is the employee's employment status/standing with company?
Does the employee have a recommendation from other employees?
What is the employee's previous G.P.A./grade performance?
Is an employee's family member eligible based on the application questions?
What is the employee's home/mailing address (including state, country)?
What is the employee's qualifying specifics?
What is the employee's previous schooling and credits?
What is the employee's citizenship (US citizen, work visa, other)?

In still another alternative embodiment, employee tuition reimbursement eligibility information is transferred from an employer human resources computer system 50 to the computer system 40 in step 128. The transferred tuition reimbursement eligibility information is parsed and loaded to the appropriate sections of the tuition reimbursement eligibility questions in step 130. As a result, the employee needs only to supply missing information and confirm the accuracy of the other information.

In the next step 114, the computer system 40 determines if the employee is eligible for tuition reimbursement by comparing the tuition reimbursement eligibility information of the employee with the reimbursement eligibility criteria of the employer. The eligibility determination is a pre-screening process to determine if the employee meets the requirements of the employer for tuition assistance. Criteria, in one example, are that the employee must be full time and have been with the employer for longer than 2 years. Generally, the employer will have eligibility requirements that correspond to the tuition reimbursement eligibility information obtained from the employee as outlined above. For example, the employer may require a minimum GPA for previous coursework and have a list of acceptable degree choices.

Typically, additional reimbursement eligibility criteria of the employer includes:
Does employer have an available program for potential students/employees to take advantage of?
Does employer subscribe to “first in, first out”? This refers to whether the employer has a cap on the total yearly amount it pays for all of the employees' tuition reimbursement. In such cases, when there is a cap, the timing of the submission often matters in the qualification process.
Does employer have appropriate funds available to provide the employees with tuition reimbursement options?

Generally, employers have specific reimbursement eligibility criteria that employees must meet to be eligible. For example, the employee must have worked at the company for a specific length of time, the employee must be a full time employee, the employee must not be on probation or have violated any companies policies, the educational course must be in an approved area of study, the courses must be from an approved institution, and the employee must receive at least a passing grade. There are often additional reimbursement eligibility criteria that must also be satisfied but that are outside the control of the employee.

If the computer system 40 determines that the employee is eligible for the tuition reimbursement, then the computer system 40 completes a tuition reimbursement application in step 116, which is submitted to the employer human resources data system 50. The application is completed using the employee supplied information along with any information provided directly from the employer human resources data system 50. As mentioned previously, in some examples, the HR data system 50 is actually owned/operated by a third party in situation that the HR function for the employer is handled on an outsourced basis.

Once completed, a tuition reimbursement application form is printed and mailed to the employee in step 124 by the computer system 40. The tuition reimbursement form provides a physical copy of the tuition reimbursement application process that the employee keeps for their personal records. In an alternative embodiment, the tuition reimbursement form is delivered electronically to the employee in the form of a downloadable document. An email containing a link to a document downloader is sent. When the employee arrives to the document downloader they are asked to verify last name before the application is made available for download and print.

If the employee is not eligible for tuition reimbursement through the employer, then the computer system 40 presents additional services offered to the employee in step 118. The additional services are services or products that help the employee continue their educational goals, but without tuition reimbursement from the employer. Typically, the additional services offered to the employee include general information about applying to schools, information about attending schools, and helping the employee complete applications for federal, state, or school financial aid. Likewise, the services encompass alternative funding options like military aid, scholarships, or grants. The additional services are free or pay-per-use by the employee or subsidized by the employer.

In an alternative embodiment, these additional services are offered by the advisor in the call center if the employee called the call center and was found to not be eligible for the employer's tuition reimbursement program.

In step 142, the computer system 40 determines if the employee has already completed a Free Application for Federal Student Aid (FAFSA) by checking an online database on the employee's behalf to determine if a FAFSA has already been completed (or filed) by the employee. The FAFSA is the required federal student aid application that must be completed on a yearly basis by all students as a condition for receiving any federal student financial aid. It is also typically used submit financial aid eligibility information to enable the apportionment/allocation state, military and college-specific aid awards.

An online database of FAFSA filings is accessed by the system by interfacing with the Department of Education's 60 filing status interface. If the employee has already completed the FAFSA, then the computer system 40 creates an “advice only” FAFSA document in step 156. In this scenario, the computer system 40 only helps track the progress of the FAFSA and provide assistance.

If the employee has not started or not completed the FAFSA, then the computer system 40 automatically starts the FAFSA using the tuition reimbursement eligibility information and financial aid eligibility information acquired during the application process in step 146. The employee will also be required to provide supplemental financial aid eligibility information to complete the FAFSA. The computer system 40 displays additional questions via the user interface to collect the required information, which is entered by the employee. These questions include:
What is the employee's marital status?
What is the employee's military service/veteran status (active, reserve, etc)?
Does the employee have dependents? If so, how many?
What is the type degree or certificate will the employee be working on?
What types of aid is the employee interested in receiving (grants, work-study, loans)?
What is the employee's criminal record?
What taxes were paid by the employee and/or their parents?
Additional school information, what was the highest level of education completed?
Does the employee have a diploma or GED?
What is the employee's high school GPA and ranking'?
What are the employee's previous SAT/ACT scores?
What advanced placement exams has the employee taken and what were the scores?
What is the employee's asset information, including non retirement investments, real estate value, farm ownership, and total asset values?
What were employee's gross earnings for the last tax year and what type of tax return was filed?
What is the number of people in household?
What was the employee's total taxable income, total deductions, actual adjusted gross income reported to IRS, taxes paid?

After the FAFSA is complete, the computer system 40 performs two operations. First, the computer system generates a personal report (one in embodiment) called the College Cost and Planning Report (CCPR) based on the financial and academic aid eligibility information entered into the computer system 40 by the employee. The CCPR includes an awards estimate that details the costs associated with attending specific educational institutions desired or of interest to the employee including such information as tuition, fees, room and board, books, activities, and other cost of living expenses. Additionally, the CCPR includes financing options, predicted financial aid awards, expected family contributions, expected out of pocket costs, and the amount of tuition reimbursement that is available from the employer, to list a few examples.

In one embodiment, the system also provides a credit hour calculator advisory function to assist the employee in maximizing available financial aid. Especially when taking classes part-time, some sources of financial aid may not be available due to the part-time status or additional aid might be available if additional credit hours are taken or a degree declared. One example is a Pell Grant. The credit hour calculator function enables the employee to test and the computer system to provide advice on the types of aid that are available with increases and decreases in credit hours taken.

This process which is a part of step 146 is illustrated in FIG. 2A.

In step 310, the computer system 40 determines whether aid would increase with more credit hours or transition to full time status.

The advisor under the guidance of the computer system 40 or the computer system directly asks the employee whether they are willing to change their status (part-time to fulltime) or increase the number of credit hours taken so that they would be eligible for aid, such as a Pell grant in step 312.

In one embodiment, if the employee is unwilling to change their status, then the computer system 40 instructs the employee or instructs the advisor 30 to notify the employee that tuition reimbursement is only available from a partnership academic institution in their situation in step 314. Such partner institutions provide discounted tuition for the employees of the employer and such arrangements are typically negotiated by the Learning and Development Department within the employer with the university or school.

On the other hand, if the employee is willing to change status, then Pell Grant tables are reviewed to determine the increase aid that is now available in step 318, and the computer system 40 provides the employee with new aid estimates, and adjusts the tuition reimbursement and FAFSA applications to reflect credit hour or status change in step 320.

Returning to FIG. 2, in the next step 154, the CCPR is then printed and mailed to the employee by the computer system 40. In alternative embodiments, the CCPR is made available as a downloadable document.

Second, the computer system 40 determines if the FAFSA is able to be immediately filed in step 158. The United States Department of Education only begins accepting applications for the subsequent school year on January 1. Furthermore, some federal, state, and school aid financial is generally given out on a “first come, first serve” basis. Thus, it is advantageous to file the FAFSA as close as possible to the first day the applications are accepted to maximize potential financial aid.

If the FAFSA is completed prior to the January 1 acceptance day, then the computer system 40 stores the FAFSA until The United States Department of Education begins accepting application on January 1 in step 160, the files the application as close as possible to the January 1 acceptance day. If the FAFSA is completed on or after the January 1, then it is submitted to the United States Department of Education 60 immediately in step 162.

In the next step 166, a status check process is performed by the computer system 40 to determine the status of the FAFSA by interfacing with the Department of Education's 60 filing status interface. The status check allows the computer system 40 to track the progress of the application. Some examples of statuses are pending, completed, incomplete, missing information, or incorrect information. Additionally, in an alternative embodiment, the computer system 40 generates a warning message or email to notify the employee 10 or an advisor 30 about deficiencies with the application.

In the next step 168, the computer system determines if the FAFSA has been fully processed. If the FAFSA has not been fully processed, then the status check process is repeated to ensure the application does not contain errors that would delay consideration of the application by The United States Department of Education 60.

In the next step 170, the follow up strategy is primarily via email, but outbound calling is also used in some examples. Generally, the computer system 40 sends an email to the employee when the FAFSA application is submitted to Department of Education 60 to let the employee know their FAFSA has been submitted. The email also instructs the employee to sign their FAFSA. In the alternative, the computer system 40 also sends email reminders periodically, until the application is fully processed. In the preferred embodiment, the computer system 40 also generates an estimated award letter. This outlines the expected award that the student will receive from the colleges to which the student is applying.

In step 172, the employees receive the award letter from college(s) to which they applied.

The employee submits the awards letter and any other required materials to the employer or through the third party entity that is handling the tuition reimbursement for the employer in step 174. This financial aid award information generated from the employee financial aid eligibility information is entered into an employee data management system and the computer system 40. In one embodiment the employee data management system is the employer human resources computer system 50. In alternative embodiments, the employee data management system is a separate computer system. From the financial aid award, the computer system 40 calculates the amount of tuition reimbursement. Since the system has provided for the submission of federal and state financial aid, in many cases the amount of tuition reimbursement are decreased since the employee's costs are reduced by virtue of the financial aid.

In one example, the computer system 40 calculates a tuition reimbursement to only cover the amount of employee's tuition that is not otherwise covered by financial aid, also termed the employee's net cost, up to the total amount of tuition reimbursement that is offered by the employer.

In another example, the computer system calculates a tuition reimbursement to cover a percentage of the employee's net cost, up to the total amount of tuition reimbursement that is offered by the employer. This approach ensures that the employee will always directly bear some of the tuition costs.

The following shows some specific examples of how the cost of the tuition reimburse (TR) benefit and/or the employee's costs are reduced by the TR system:

Example A:
Employer's annual TR
Benefit $2,500
Employee receives Pell and additional grant aid

| | *Without TR system | With TR system |
|---|---|---|
| XYZ University Cost | $12,000 | $12,000 |
| Grants Paid | $0 | $10,000 |
| Employer's TR benefit | $2,500 | $2,000 |
| Employee pays | $9,500 | $0 |

*Assumes FAFSA was not filed
Results:
Savings to employer $500
Savings to employee $9,500

The following scenario will only happen when a TR program first begins and there is the opportunity to receive retroactive aid.

Example B—Retroactive Aid
Employer's annual TR Benefit $5,250
Employee is partially Pell eligible

| | *Without TR system |
|---|---|
| XYZ University cost per semester | $3,000 |
| Grants Paid | $0 |
| Employer's TR benefit | $3,000 |
| Employee pays | $0 |

*Assumes FAFSA was not filed
1. After employee is reimbursed from the employer, the TR system is used.
2. Employee files a FAFSA through TR system
3. Employee receives a retroactive Pell award for the amount of $1,800
Results:
Grant paid to employee $1,800
Employer receives $0

Example C: Savings to employer
Employer's annual TR Benefit $4,000
Employee is fully Pell eligible

| | *Without TR system | With TR system |
|---|---|---|
| XYZ University Cost | $2,300 | $2,300 |
| Grants Paid | $0 | $2,300 |
| Employer's TR benefit | $2,300 | $0 |
| Employee pays | $0 | $0 |

*Assumes FAFSA was not filed
Results:
Savings to employer $2,300
Savings to employee $0

Example D: Savings to employer and employee
Employer's annual TR Benefit $4,000
Employee is fully Pell eligible

| | *Without TR system | With TR system |
|---|---|---|
| XYZ University Cost | $6,000 | $6,000 |
| Grants Paid | $0 | $5,550 |
| Employer's TR benefit | $4,000 | $450 |
| Employee pays | $2,000 | $0 |

*Assumes FAFSA was not filed
Results:
Savings to employer $3,550
Savings to employee $2,000

Example E: Savings to employee
Employer's annual TR Benefit $4,000
Employee is partially Pell eligible

| | *Without TR system | With TR system |
|---|---|---|
| XYZ University Cost | $6,000 | $6,000 |
| Grants Paid | $0 | $1,500 |
| Employer's TR benefit | $4,000 | $4,000 |
| Employee pays | $2,000 | $500 |

*Assumes FAFSA was not filed
Results:
Savings to employer $0
Savings to employee $1,500

Based on predefined employer policies, the computer system 40 approves some, all, or none of the tuition reimbursement for the employee in step 176. In an alternative embodiment, the employer may make additional determinations of whether to approve the tuition reimbursement and for how much. In the next step 178, a reimbursement check is generated by the computer system 40 and mailed to the employee. Alternatively, if the tuition reimbursement is not approved by the employer, then no reimbursement is provided to the employee in step 177. In some examples, the computer system 40 interfaces with the employer's payroll system so that the tuition reimbursement funds are included with the check that the employee receives for payroll.

Lastly, data are transmitted by the billing and reporting system 600 of the computer system 40 to the employer's databases in the human resources computer system 50 to update the employer's records in step 180.

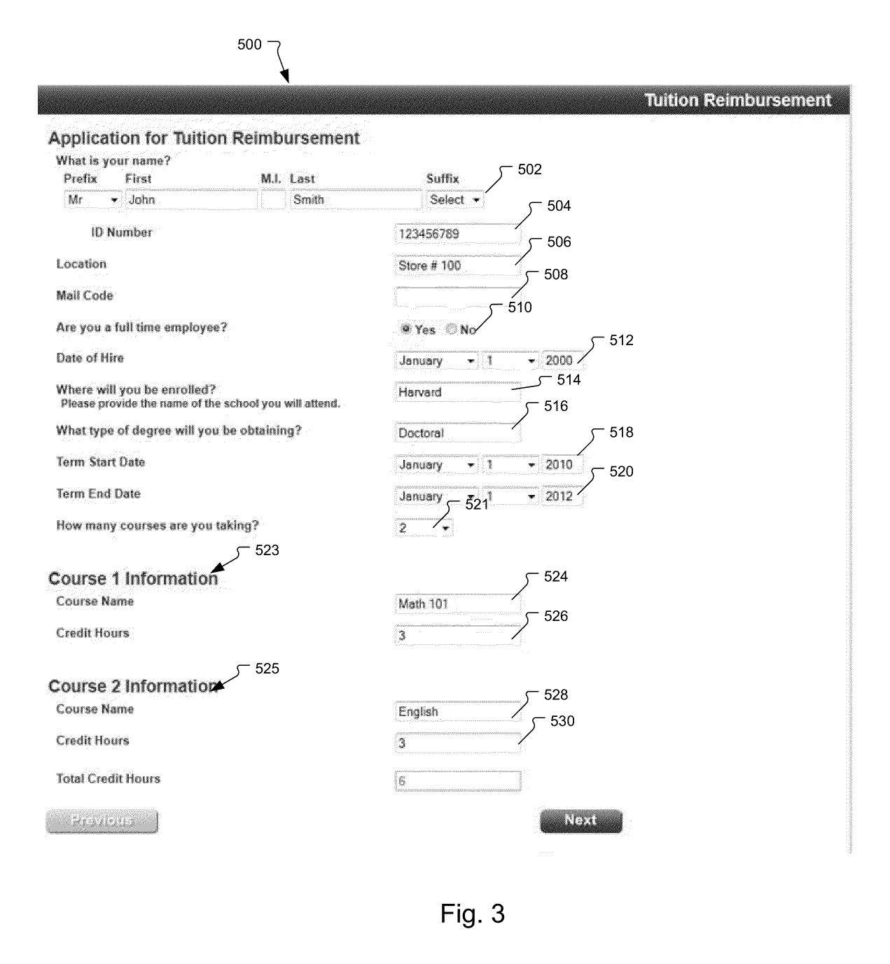

FIG. 3 illustrates an example of the graphical user interface and online tuition reimbursement application 500 completed by an employee 10 during the application process.

The tuition application 500 is customizable based on the employer/company's predefined rules and policies governing tuition reimbursement. The employer is able to decide which tuition reimbursement eligibility questions to ask the employee as well as the necessary minimum requirements for tuition reimbursement.

In the example application for tuition reimbursement, an employee must enter personal information such as name 502, ID number 504, office location 506, mail code 508, whether they are a full time employee 510, and date of hire 512. Further, the employee must enter school information such as where they will be enrolled 514, type of degree 516, term start date 518, term end date 520, and how many classes the employee plans to take 521. Depending on the number of classes selected, a corresponding number of course information sections 523, 525 will be generated. Thus, the employee must also include course information such as course name 524, 528 and credit hours 526, 530.

Because the tuition reimbursement application is customizable, the information within the application could include more questions, less questions, or could be modified as by the employer. Additionally, the employer could have location specific application for employees in different office locations.

Additionally, the tuition reimbursement eligibility information collected by the computer system 40 during the application process can be incorporated into the CCPR.

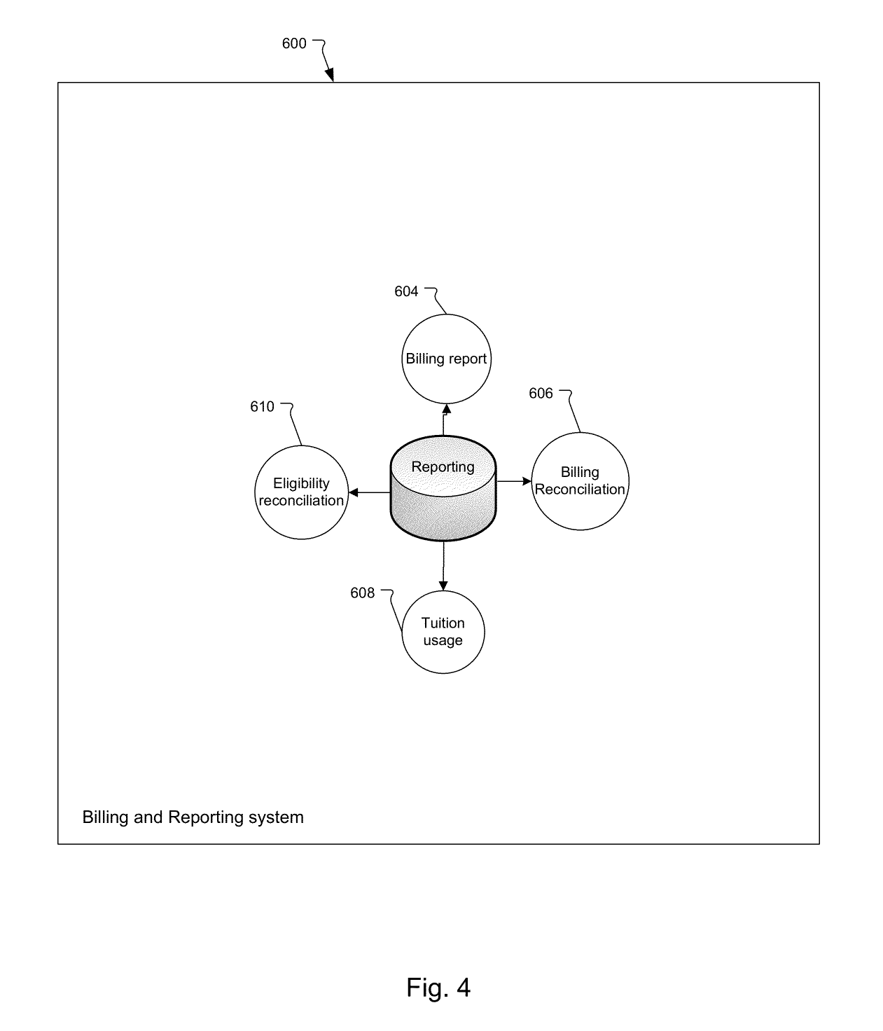

FIG. 4 illustrates the billing and reporting system 600 that communicates with the computer system 40.

The billing and reporting system 600 enables the employer, employee, and computer system 40 to record, store and analyze the collected data related to the administration of the tuition reimbursement program.

For example, a billing report 604 is able to be generated by the computer system 40. The billing report 604 includes details such as cost to administer benefits to the employer, total available funds for the tuition reimbursement program, number of employees enrolled in the program, outstanding balances owed to each employee, to list a few examples.

The billing reconciliation report 606 provides details about:

the number of applications initiated by phone,

the number of pending applications,

the number of completed applications,

the number of applications approved,

the number of applications denied, and

the number of applications ineligible.

The tuition reimbursement usage report 608 provides details such as the amount of tuition reimbursement provided to each employee, amount distributed to date, the amount of grant or scholarship aid received by the employees, and a projected amount of tuition reimbursement expected to be paid. The report can be an annual report (either fiscal or academic), quarterly, or semi-annual.

Eligibility reconciliation reports 610 are also generated.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computerized method for managing tuition reimbursement for an employee by an employer, the method comprising:
entering employee tuition reimbursement eligibility information into a computer system;
determining whether the employee is eligible for tuition reimbursement based on tuition reimbursement eligibility criteria;
if the employee is determined to be eligible for the tuition reimbursement, entering employee financial aid eligibility information into the computer system; and
submitting an application for financial aid that includes the employee financial aid eligibility information obtained from the employee.

2. The method according to claim 1, further comprising entering into the computer system financial aid awards that were generated from the application for financial aid of the employee.

3. The method according to claim 2, further comprising the computer system determining an amount of tuition reimbursement based on the financial aid awards.

4. The method according to claim 1, wherein the employee tuition reimbursement eligibility information includes employment status and/or tenure of employment.

5. The method according to claim 1, wherein the tuition reimbursement eligibility criteria for the employer includes whether a program includes appropriate funds for reimbursement of tuition expenses of the employee.

6. The method according to claim 1, wherein at least some of the employee tuition reimbursement eligibility information is transferred from a human resources computer system.

7. The method according to claim 1, wherein the employee financial aid eligibility information includes salary information and/or asset information.

8. The method according to claim 1, further comprising transferring the employee financial aid eligibility information to a Free Application for Federal Student Aid form.

9. The method according to claim 8, wherein the computer system generates a tuition reimbursement check amount that is determined in part based on the financial aid awards.

10. The method according to claim 1, wherein the step of entering the employee tuition reimbursement eligibility information and the employee financial aid eligibility information includes entering the information over the internet.

11. The method according to claim 1, further comprising enabling the employee to test the availability of aid with increases or decreases in the credit hours taken, status changes, or modification of other parameters.

12. A computer system for managing tuition reimbursement for an employee by an employer, the computer system receiving employee tuition reimbursement eligibility information, determining whether the employee is eligible for tuition reimbursement based on tuition reimbursement eligibility criteria, if the employee is determined to be eligible for the tuition reimbursement, receiving employee financial aid eligibility information, and generating and submitting an application for financial aid that includes the employee financial aid eligibility information obtained from the employee.

13. The system according to claim 12, further comprising the computer system receiving financial aid award information that were generated from the application for financial aid of the employee.

14. The system according to claim 12, further comprising the computer system determining an amount of tuition reimbursement based on the financial aid awards.

15. The system according to claim 12, wherein employee tuition reimbursement eligibility information includes employment status and tenure of employment.

16. The system according to claim 12, wherein the tuition reimbursement eligibility criteria for the employer includes whether a program includes adequate funds for reimbursement of expenses of the employee.

17. The system according to claim 12, wherein at least some of the employee tuition reimbursement eligibility information is transferred from a human resources computer system.

18. The system according to claim 12, wherein the employee financial aid eligibility information includes salary information and asset information.

19. The system according to claim 12, wherein the computer system transfers the employee financial aid eligibility information to a Free Application for Federal Student Aid form.

20. The system according to claim 19, wherein the computer system generates a tuition reimbursement check amount that is determined in part based on the financial aid awards.

21. The system according to claim 12, wherein the employee tuition reimbursement eligibility information and the employee financial aid eligibility information are entered over the internet.

22. The system according to claim 12, further comprising enabling the employee to test the availability of aid with increases or decreases in the credit hours taken.

23. A computerized method for managing tuition reimbursement for an employee by an employer, the method comprising:
receiving employee tuition reimbursement eligibility information;
determining whether the employee is eligible for tuition reimbursement based on tuition reimbursement eligibility criteria;
if the employee is determined to be eligible for the tuition reimbursement, determining if financial aid eligibility of the employee will improve with changes in status; and
then determining financial aid eligibility based on a new status.

24. The method according to claim 23, wherein the new status is a fulltime status.

25. The method according to claim 23, wherein the new status is an increased number of credit hours.

26. The method according to claim 23, further comprising limiting available tuition reimbursement if the employee is unwilling to transition to a new status.

27. A computer system for managing tuition reimbursement for an employee by an employer, the computer system receiving employee tuition reimbursement eligibility information, determining whether the employee is eligible for tuition reimbursement based on tuition reimbursement eligibility criteria, if the employee is determined to be eligible for the tuition reimbursement, determining if financial aid eligibility of the employee will improve with changes in status, and then determining financial aid eligibility based on a new status.

28. The system according to claim 27, wherein the new status is a fulltime status.

29. The system according to claim 27, wherein the new status is an increased number of credit hours.

30. The system according to claim 27, further comprising limiting available tuition reimbursement if the employee is unwilling to transition to a new status.
